(19) United States
(12) Patent Application Publication
(10) Pub. No.: US 2026/0003312 A1
(43) Pub. Date: Jan. 1, 2026

(54) SHEET PROCESSING APPARATUS AND IMAGE FORMING SYSTEM INCLUDING SHEET PROCESSING APPARATUS

(71) Applicant: Konica Minolta, Inc., Tokyo (JP)

(72) Inventor: Eriko KOZAKI, Tokyo (JP)

(21) Appl. No.: 19/247,341

(22) Filed: Jun. 24, 2025

(30) Foreign Application Priority Data
Jun. 28, 2024 (JP) 2024-104647

(51) Int. Cl. G03G 15/00; B26D 1/24; B26D 5/02

(52) U.S. Cl. CPC G03G 15/6582; B26D 1/245; B26D 5/02; G03G 2215/00814

(57) ABSTRACT

A sheet processing apparatus processes a sheet by using a rotary blade. The sheet processing apparatus includes: a rotary blade unit that supports the rotary blade such that the rotary blade is rotatable on a rotation shaft and movable in an axial direction of the rotation shaft; a guide member that is supported by the rotation shaft and that guides part of the sheet; and a rotation stopper that prevents rotation of the guide member. The rotation stopper is mounted on the rotary blade unit.

### CROSS-REFERENCE TO RELATED APPLICATIONS

The present invention claims priority under 35 U.S.C. § 119 to Japanese Patent Application No. 2024-104647 filed on Jun. 28, 2024, the entire contents of which being incorporated herein by reference.

### TECHNICAL FIELD

The present invention relates to a sheet processing apparatus and an image forming system.

### BACKGROUND ART

A known sheet processing apparatus rubs an upper rotary blade and a lower rotary blade against each other to cut a sheet in a conveyance direction and divide the sheet into multiple pieces in a direction orthogonal to the conveyance direction (see Japanese Unexamined Patent Publication No. 2012-91278).

Such an apparatus includes a guide member that guides the sheet to a predetermined conveyance path. The guide member prevents a sheet having weak stiffness from hanging down and bending at the corner thereof while being conveyed.

There is a fixed guide member that is fixed at a predetermined position and a movable guide member that is movable in a sheet width direction. The fixed guide member is disposed at the end in the conveyance direction of a blade housing that houses the rotary blade. Therefore, the fixed guide member cannot support the sheet in the blade housing after the sheet enters the blade housing. To deal with this, it is effective to provide a movable guide member outside the blade housing and prevent the sheet from hanging down with the movable guide member.

The movable guide member provided outside the blade housing, which houses the rotary blade, is movable in the axial direction of the rotary blade. After the sheet enters the blade housing, the movable guide member at the outside of the blade housing supports the sheet and certainly prevents the sheet from bending. However, since the movable guide member is disposed on the rotation shaft that supports the rotary blade, the movable guide member rotates along with the rotation of the rotation shaft and cannot maintain its posture unless a rotation stopper is provided.

Therefore, in a known art, as illustrated in FIG. 21, support rails 91 and 92 are provided over the entire width between the side plates 21a and 21b of the unit housing 21 facing each other. The support rails 91 and 92 are substantially parallel to rotation shafts 31 and 32 that support the blade housings R1 to R4. The movable guide member 90 is locked by the support rails 91 and 92 such that the movable guide member 90 can slide thereon. Thus, the movable guide member 90 is prevented from rotating.

However, the above-described support rails for preventing rotation of the movable guide member are disposed outside the radial direction of the rotary blade so as not to interfere with the rotary blade. When part of the guide member near the rotation shaft is urged to move the guide member in the axial direction, a large rotation moment acts on part of the guide member locked to the support rail because the urged part of the guide member is separated from the locked part in the radial direction. As a result, torsion between the rotation shaft and the support rail or torsion (rubbing) of the guide member may occur, which prevents the guide member from moving smoothly and lead to operation failure.

The present invention has been made in view of such circumstances. The present invention provides: a sheet processing apparatus that includes a guide member movable in the sheet width direction and that can secure smooth movement of the guide member while preventing rotation of the guide member; and an image forming system including the sheet processing apparatus.

### SUMMARY OF THE INVENTION

To achieve at least one of the abovementioned objects, according to an aspect of the present invention, there is provided a sheet processing apparatus that processes a sheet using a rotary blade, the sheet processing apparatus including: a rotary blade unit that supports the rotary blade such that the rotary blade is rotatable on a rotation shaft and movable in an axial direction of the rotation shaft; a guide member that is supported by the rotation shaft and that guides part of the sheet; and a rotation stopper that prevents rotation of the guide member, wherein the rotation stopper is provided to the rotary blade unit.

### BRIEF DESCRIPTION OF DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 illustrates a schematic configuration of an image forming system according to the present embodiment;

FIG. 2 is a functional block diagram of a control structure of the image forming system according to the present embodiment;

FIG. 3 is a perspective view of the schematic configuration of a slitter (a bleed-width changeable slitter) according to the present embodiment, wherein the slitter is viewed from the upstream side in the sheet conveyance direction;

FIG. 4 is a perspective view of the schematic configuration of the slitter (the bleed-width changeable slitter) according to the present embodiment, wherein the slitter is viewed from the downstream side in the sheet conveyance direction;

FIG. 5 illustrates the inside of the slitter (the bleed-width changeable slitter) viewed from the above according to the present embodiment;

FIG. 6 illustrates a schematic configuration of a cutter used in the slitter according to the present embodiment;

FIG. 7 illustrates a drive mechanism that rotates a rotation shaft of the slitter according to the present embodiment;

FIG. 8 is a perspective view of the drive mechanism that drives the cutters in the axial direction of the rotation shaft, wherein the drive mechanism is viewed from the upstream side in the sheet conveyance direction;

FIG. 9 is a plan view for explaining the drive mechanism the drives the cutters in the axial direction of the rotation shaft;

FIG. 10 illustrates part of the cutters of the slitter according to the present invention, wherein the part is viewed from the upstream side in the sheet conveyance direction;

FIG. 11 is a perspective view of one of the cutters of the slitter according to the present invention as viewed from the upstream side in the sheet conveyance direction;

FIG. 12 illustrates part of the cutters of the slitter according to the present invention, wherein the part is viewed from the downstream side in the sheet conveyance direction;

FIG. 13 illustrates part of the cutters of the slitter according to the present invention viewed from the top side;

FIG. 14 is a perspective view of a pair of upper and lower movable guide members according to the present invention;

FIG. 15 illustrates the movable guide members supported by the upper and lower rotation shafts on the upstream and downstream sides as viewed from the axis direction of the rotation shafts;

FIG. 16 is a perspective view of a state where rotation stoppers are fixed to a side plate fixed to the blade housing (the upper housing and the lower housing);

FIG. 17 is a perspective view of a state where the rotation stoppers of FIG. 16 are attached to the movable guide member;

FIG. 18 is an exploded perspective view of the blade housing that houses the rotary blade unit, the side plates, the rotation stoppers, and the movable guide members before being assembled;

FIG. 19 is a plan view of the blade housing that houses the rotary blade unit, the side plates, the rotation stoppers, and the movable guide members before being assembled;

FIG. 20 is a view for explaining the relation between a spring elastically mounted between the blade housing that houses the rotary blade unit and the movable guide member and other springs; and

FIG. 21 is a perspective view for explaining the structure of rotation stoppers applied to a known movable guide member.

### DETAILED DESCRIPTION

Hereinafter, one or more embodiments of the present invention will be described with reference to the drawings. However, the scope of the invention is not limited to the disclosed embodiments.

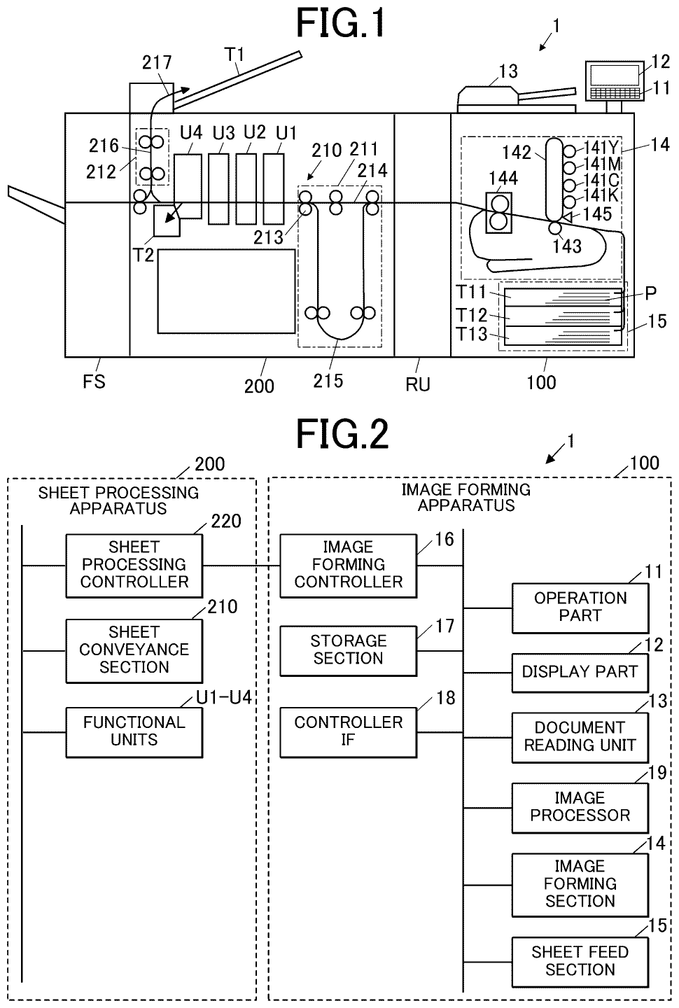

As shown in FIG. 1 and FIG. 2, the image forming system 1 according to the present embodiment includes an image forming apparatus 100, a relay unit RU, a sheet processing apparatus 200, and a finisher FS.

The image forming apparatus 100 forms a color image by an electrophotographic method on the basis of image data obtained by reading an image from a document or image data received from an external device. The image forming apparatus 100 includes an operation part 11 and a display part 12, a document reading unit 13, an image forming section 14, a sheet feed section 15, an image forming controller 16, a storage section 17, a controller interface (IF) 18, and an image processing section 19.

The operation part 11 includes a touch screen formed to cover a display screen of the display part 12, and various operation buttons such as numeric buttons and a start button. The operation part 11 outputs an operation signal based on a user's operation to the image forming controller 16.

The display part 12 includes a liquid crystal display (LCD) and displays various screens in accordance with an instruction of a display signal input from the image forming controller 16.

The document reading unit 13 includes an automatic document feeder (ADF, sheet feed device), a scanner, and the like, and outputs image data obtained by reading the image of the document to the image forming controller 16.

The image forming section 14 forms an image on a sheet supplied from the sheet feed section 15, based on the image data subjected to image processing. The image forming section includes photosensitive drums 141Y, 141M, 141C, and 141K corresponding to colors of yellow (Y), magenta (M), cyan (C), and black (K), an intermediate transfer belt 142, a secondary transfer roller 143, a fixing section 144, and a density sensor 145.

The photosensitive drum 141Y is uniformly charged and is then scanned and exposed by a laser beam based on the image data for a yellow color, so that an electrostatic latent image is formed. Next, the yellow color is applied to the electrostatic latent image on the photosensitive drum, and development is performed. For the other photosensitive drums 141M, 141C, and 141K, the same processing as that for the photosensitive drum 141Y is performed, except that the colors to be handled are different.

The toner images in the respective colors formed on the photosensitive drums 141Y, 141M, 141C, and 141K are sequentially transferred onto the rotating intermediate transfer belt 142 (primary transfer). That is, a color toner image in which the toner images of four colors are superimposed is formed on the intermediate transfer belt 142. The color toner image on the intermediate transfer belt 142 is collectively transferred onto a sheet by the secondary transfer roller 143 (secondary transfer).

The fixing section 144 includes a heating roller that heats the sheet onto which the color toner image has been transferred and a pressure roller that pressurizes the sheet, and fixes the color toner image onto the sheet by heating and pressurizing.

The sheet feed section 15 includes sheet feed trays T11 to T13 and supplies the sheet to the image forming section 14. Each of the sheet feed trays T11 to T13 stores sheets of a sheet type and a size determined in advance for each sheet feed tray.

The image forming controller 16 includes a CPU, a ROM, and a memory.

The CPU reads out various processing programs stored in the ROM and controls the operation of each unit of the image forming apparatus 100 according to the programs. When performing sheet processing on the output sheet, the CPU instructs the sheet processing controller 220 of the sheet processing apparatus 200 to perform predetermined sheet processing.

The sheet processing apparatus 200 performs sheet processing on the sheet output from the relay unit RU as necessary. Examples of the sheet processing include slitter processing, gap slitter processing, cutting processing in a cross direction, creasing processing, and FD/CD perforation processing. These types of sheet processing are not essential, and sheet processing is performed only when instructed by the image forming apparatus 100. When there is no sheet processing, the sheet processing apparatus 200 conveys the conveyed sheet to the finisher FS as it is.

The sheet processing apparatus 200 includes a sheet conveyance section 210, functional units (sheet processing modules) U1 to U4, a purge tray T1 that receives sheets purged from the sheet processing apparatus 200, and a card tray T2 that receives sheets cut into a predetermined size by the sheet processing apparatus 200.

The sheet conveyance section 210 conveys the sheet conveyed from the relay unit RU to the functional units U1 to U4. Thereafter, the sheet subjected to the sheet processing by the functional units is conveyed to various trays (the purge tray T1 and the card tray T2) or the finisher FS.

The sheet conveyance section 210 includes a long sheet conveyance section 211 and a purge conveyance section 212. The sheet conveyance section 210 includes a plurality of conveyance roller pairs 213 and conveyance paths 214 to 217 as illustrated in FIG. 1. That is, the sheet conveyance section 210 includes a straight conveyance path 214 that corrects a skew of the sheet to be conveyed to the functional unit U1, and a bypass path 215 that bypasses the long sheet to be conveyed to the functional unit U1 to perform alignment in a CD-direction (sheet width direction). Furthermore, the sheet conveyance section 210 includes a reverse sheet ejection path 216 that reverses the sheet after the sheet processing by the functional units U1 to U4 and ejects the sheet to the finisher FS, and a dual purpose path 217 that serves as both a sheet ejection path that ejects the sheet to the purge tray T1 and a reverse path that reverses the sheet.

The sheet conveyance section 210 conveys, by a plurality of conveyance roller pairs 213, the printing sheet conveyed from the image forming apparatus 100 to the sheet processing section (functional units U1 to U4). Furthermore, the sheet conveyance section 210 conveys the printing sheet subjected to the sheet processing to the finisher FS. In the finisher FS, the sheet after the image formation is subjected to stapling, folding, punching, and the like.

The functional units U1 to U4 perform sheet processing on the conveyed sheet P.

The functional units U1 to U4 are manually selected and installed by a user. For example, the most upstream functional unit U1 may be a top/bottom slitter, and the most downstream functional unit U4 may be a CD cutter (CD cutting unit) for CD cutting. In this case, the functional units U2 and U3 may be selected from a gap cutting slitter, a creaser (downward projection) or a creaser (upward projection), FD-perforation, CD-perforation, and the like.

The gap cutting slitter cuts off, along the sheet conveyance direction, a margin between products adjacent to each other in a direction orthogonal to the sheet conveyance direction. The creaser (downward projection) or the creaser (upward projection) performs crease processing on a sheet. The FD perforation or the CD perforation performs FD/CD perforation processing for forming perforations in the sheet.

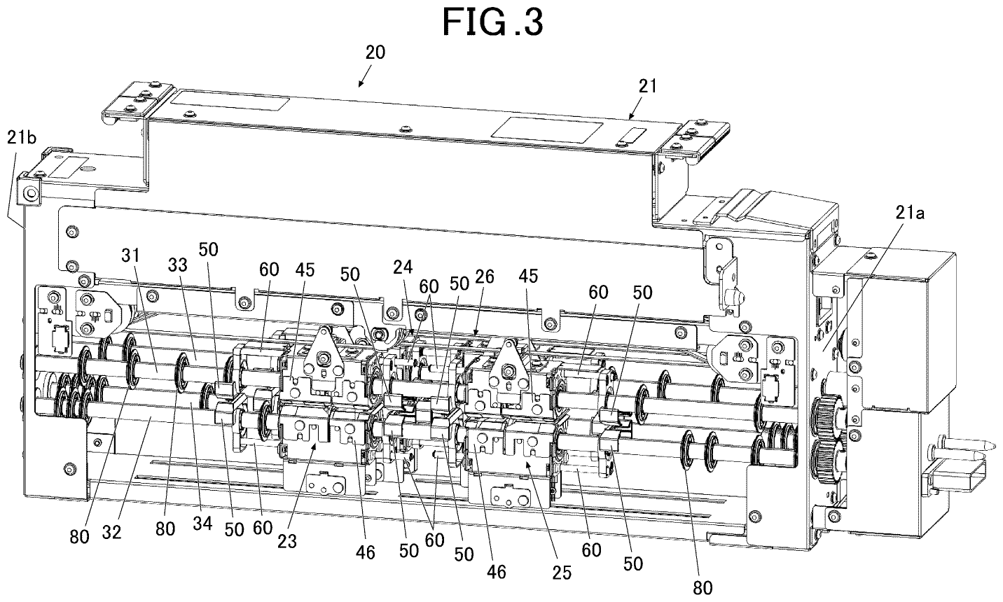

In the above-described functional units U1 to U4, modules selected in accordance with functions required by the user are detachably attached to unit housing receivers, and required functions are completed on a module-by-module basis. FIG. 3 shows a gap-width changeable slitter 20 capable of adjusting the bleed width and cutting off the bleed among the bleed cutting slitters.

Hereinafter, the bleed-width changeable slitter 20 will be described in detail. Note that the sheet conveyance direction may be the front-back direction of the sheet, the upstream side in the sheet conveyance direction may be referred to as a near side of the sheet, and the downstream side in the sheet conveyance direction may be referred to as a farther side. Further, the horizontal direction orthogonal to the sheet conveyance direction may be referred to as a right-left direction of the sheet.

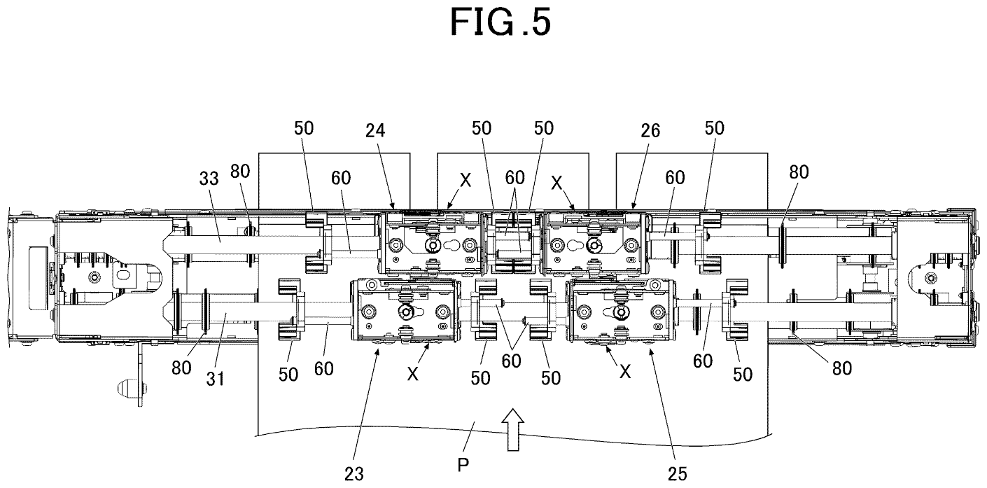

As illustrated in FIG. 3 to FIG. 5, the bleed-width changeable slitter 20 includes a plurality of cutters 23, 24, 25, and 26 for bleed cutting when the sheet P is divided into a plurality of pieces in the direction orthogonal to the conveyance direction.

That is, in the unit housing 21, pairs of cutters are disposed at different positions with respect to the direction orthogonal to the sheet conveyance direction of the sheet conveyed by the sheet conveyance section 210. In each pair, the cutters are disposed at different positions in the sheet conveyance direction.

In this example, the cutters (23 and 24, 25 and 26) are disposed at two different positions with respect to the sheet conveyance direction. There are two pairs of cutters (the pair of 23 and 24, the pair of 25 and 26) arranged at different positions in the direction orthogonal to the conveyance direction. In each pair, the cutters are disposed at two different positions in the sheet conveyance direction. Therefore, in this embodiment, the cutters 23, 24, 25, and 26 are provided at four positions of the front, back, left, and right positions in the sheet conveyance direction in the unit housing 21.

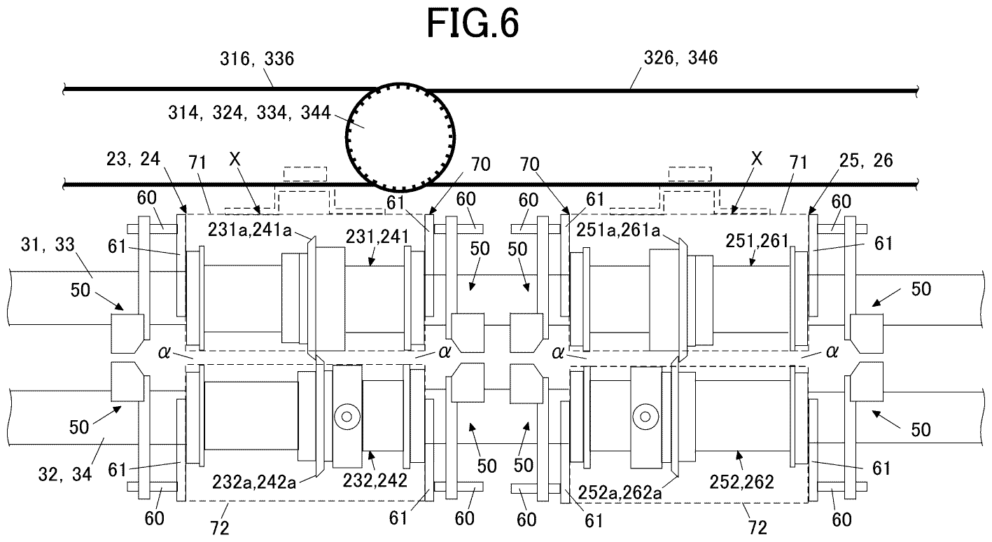

As illustrated in FIG. 6, the respective cutters 23, 24, 25, and 26 are supported by pairs of upper and lower rotation shafts (31 and 32, and 33 and 34) extending in a direction orthogonal to the sheet conveyance direction. Two pairs of upper and lower rotation shafts (31 and 32, and 33 and 34) are provided at a predetermined interval in front and rear in the sheet conveyance direction. The rotation axes are provided to be parallel to each other.

On the upper rotation shafts 31 and 33, upper blade units 231, 241, 251, and 261 as rotating slide bodies including upper cutter blades 231a, 241a, 251a, and 261a are provided so as to be movable in the axial direction of the rotation shafts 31 and 33. On the lower rotation shafts 32 and 34, lower blade units 232, 242, 252, and 262 as rotary slide bodies including lower cutter blades 232a, 242a, 252a, and 262a are provided so as to be movable in the axial direction of the rotation shafts 32 and 34.

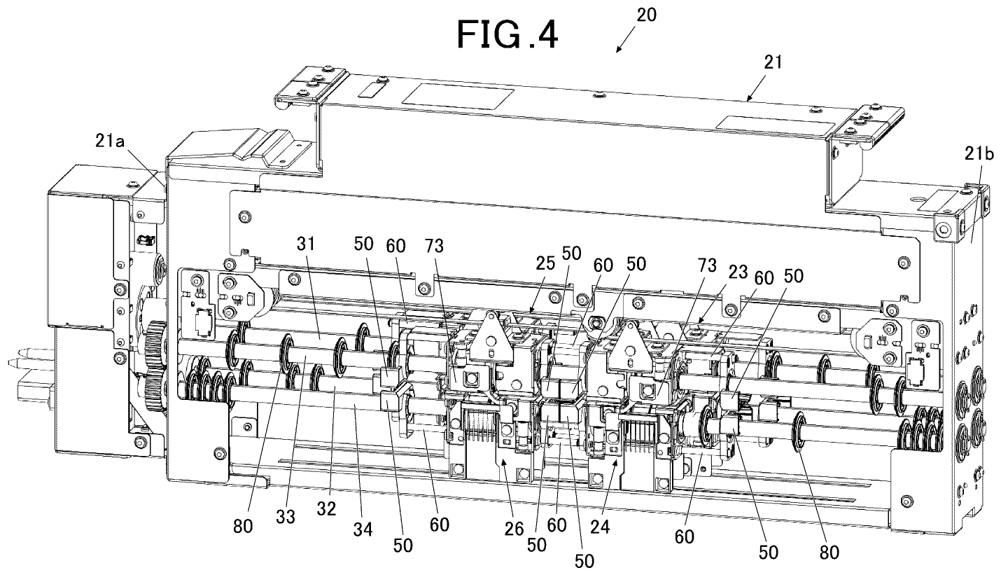

An upper housing 71 is attached around the upper blade units 231, 241, 251, and 261. A lower housing 72 is attached around the lower blade units 232, 242, 252, and 262. These blade housings 70 (the upper housing 71 and the lower housing 72) are connected to each other by a connecting member 73 (shown in FIG. 4). Thus, the upper blade units 231, 241, 251, and 261 and the lower blade units 232, 242, 252, and 262 integrally slide on the rotation shaft.

The upper housing 71 and the lower housing 72 support the upper blade units 231, 241, 251, and 261 (the upper cutter blades 231a, 241a, 251a, and 261a) and lower blade units 232, 242, 252, and 262 the (lower cutter blades 232a, 242a, 252a, and 262a), which form upper and lower pairs, such that the upper and lower blade units are rotatable on their respective rotation shafts.

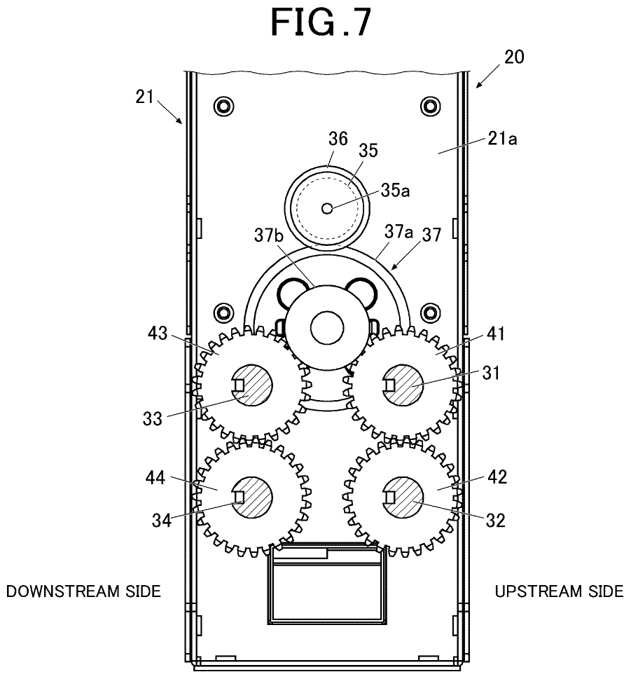

As illustrated in FIG. 7, the respective rotation shafts 31, 32, 33, and 34 are driven to rotate at the same time by a drive motor 35 as a common power source.

The drive motor 35 is disposed outside a side plate 21a as one of side plates 21a and 21b that form a pair in the longitudinal direction of the unit housing 21. A motor shaft 35a of the drive motor 35 protrudes into the unit housing 21 via the side plate 21a. The four rotation shafts 31 to 34 are disposed below the motor shaft 35a at predetermined intervals in the sheet conveyance direction (front-rear direction) and the up-down direction. The rotation shafts 31 to 34 are arranged in parallel to each other along the longitudinal direction of the unit housing 21. The rotation shafts 31 to 34 are rotatably supported by a pair of side walls 21a and 21b that face each other in the longitudinal direction of the unit housing 21. These rotation shafts 31 to 34 are rotationally driven at the same time by a series of gears.

In the drive motor 35, a driving gear 36 attached to the motor shaft 35a is engaged with a large-diameter gear 37a of a reduction gear 37. In the reduction gear 37, the large-diameter gear 37b and a small-diameter pinion 37a are concentrically integrated. The pinion 37b engages with transmission gears 41 and 43 that are fitted to the upper rotation shafts 31 and 33 of the two pairs of upper and lower rotation shafts (31 and 32, and 33 and 34). The transmission gears 41 and 43 on the upper side engage with transmission gears 42 and 44 that are fitted to the lower rotation shafts 32 and 34 of the two pairs of upper and lower rotation shafts.

When the drive motor 35 rotates, the rotational power of the drive motor 35 is transmitted to the upper transmission gear 41 and 43 via the reduction gear 37. The rotational power is then transmitted to the lower transmission gears 42 and 44 via the upper transmission gears 41 and 43. Thus, the four rotation shafts 31 to 34 rotate simultaneously. As a result, the pairs of upper and lower cutter blades 231a, 232a, 251a, and 252a on the upstream side each cuts one side of the bleed region of the sheet conveyed therebetween. Further, the pairs of upper and lower cutter blades 241a, 242a, 261a, and 262a on the downstream side cut the other side of the bleed region of the sheet conveyed therebetween.

### (Drive Mechanism of Upper Blade Unit and Lower Blade Unit)

The positions of the upper blade units 231, 241, 251 and 261 and the lower blade units 232, 242, 252, and 262, which form upper and lower pairs as described above, in the axial direction of the rotation shaft are interlocked by the connecting member 73 attached to the upper housing 71 and the lower housing 72. Therefore, the upper cutter blades 231a, 241a, 251a, 261a and the lower cutter blades 232a, 242a, 252a, 262a can slide in the axial direction on the rotation shaft while maintaining a state in which they are not separated in the axial direction. The upper blade units, the lower blade units, and the blade housing 70 that houses the upper and lower blade units (the upper housing 71 and the lower housing 72) constitute the rotary blade unit X. The rotary blade unit X may include additional members, such as metal plates.

The rotary blade unit X can slide in the axial direction of the rotation shafts 31 to 34 by a driving belt fixed to the upper housing 71.

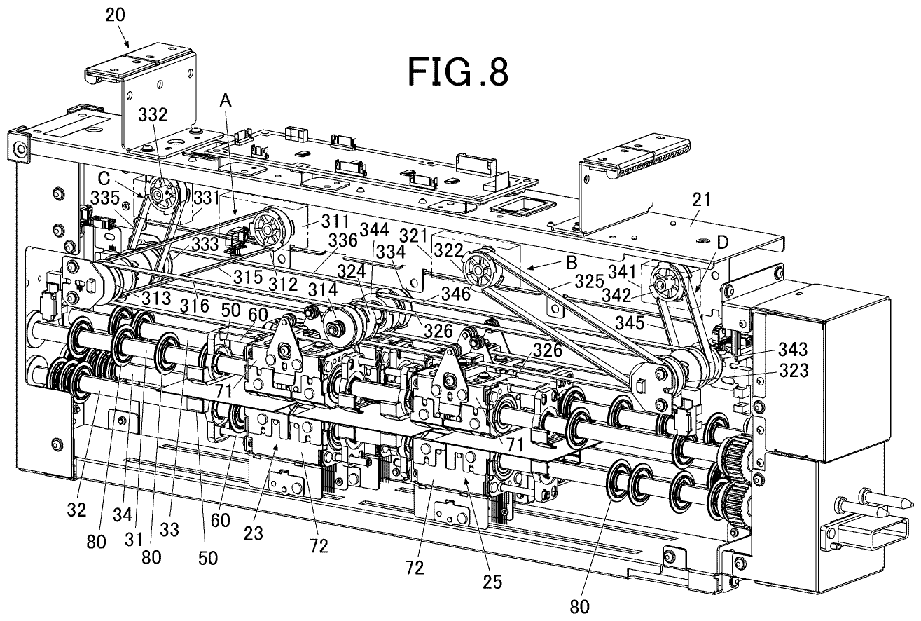

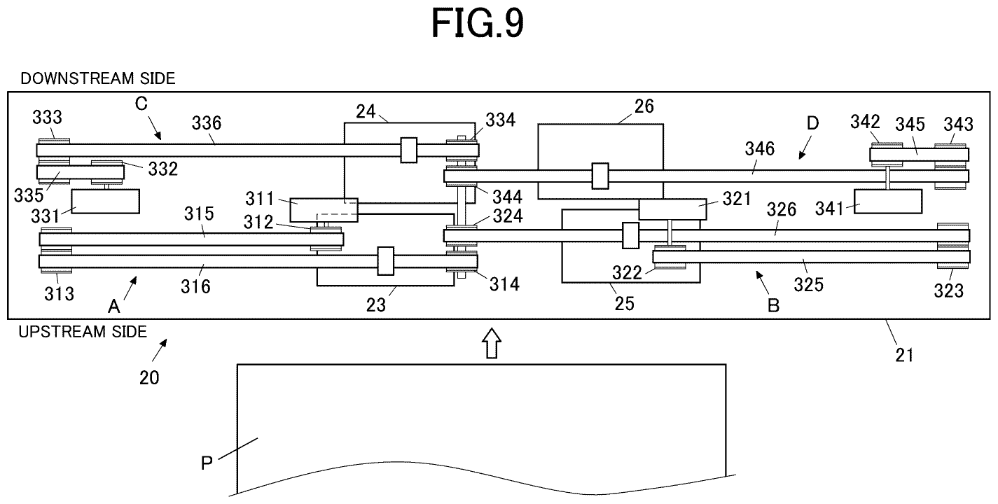

As illustrated in FIG. 8 and FIG. 9, the left and right cutters 23 and 25 on the upstream side and the left and right cutters 24 and 26 on the downstream side in the conveyance direction are driven by belts using separate drive motors 311, 321, 331, and 341 as power sources.

Among the upstream-side cutters 23 and 25 in the conveyance direction, the cutter 23 on the left side when viewed from the upstream side is driven by the drive mechanism A. The drive mechanism A has the following configuration.
(1) A first drive motor 311 provided on the left side when viewed from the upstream side with respect to the upper center in the unit housing 21
(2) A first driving pulley 312 fixed to a motor shaft of the first drive motor 311
(3) A first intermediate pulley 313 disposed near the end of one side (left side when viewed from the upstream side) in the longitudinal direction of the unit housing 21, above the upper rotation shaft 31, below the first drive pulley 312, and rotatably disposed around an axis parallel to the motor shaft of the first drive motor 311
(4) A first terminal pulley 314 disposed substantially at the center of the unit housing 21 in the longitudinal direction and above the upper rotation shaft 31 to be rotatable on a shaft parallel to the motor shaft of the first drive motor 311
(5) A first endless belt 315 stretched between the first drive pulley 312 and the first intermediate pulley 313
(6) A second endless belt 316 stretched between the first intermediate pulley 313 and the first terminal pulley 314

The upper part of the upper housing 71 is locked to the upper blade unit 231, which constitutes the cutter 23, and fixed to the second endless belt 316. Therefore, the position of the cutter 23 on the left side when viewed from the upstream side in the conveyance direction on the rotation shafts 31 and 32 is adjusted by controlling the first drive motor 311.

Among the upstream-side cutters in the conveyance direction, the cutter 25 on the left side when viewed from the upstream side is driven by the drive mechanism B. The drive mechanism B has the following configuration.
(1) A second drive motor 321 provided on the right side when viewed from the upstream side with respect to the upper center in the unit housing 21
(2) A second driving pulley 322 fixed to a motor shaft of the second drive motor 321
(3) A second intermediate pulley 323 disposed near the end of the other side (right side when viewed from the upstream side) in the longitudinal direction of the unit housing 21, above the upper rotation shaft 31, below the second drive pulley 322, and rotatably disposed around an axis parallel to the motor shaft of the second drive motor 321
(4) A second terminal pulley 324 disposed substantially at the center of the unit housing 21 in the longitudinal direction and above the upper rotation shaft 31 to be rotatable on a shaft parallel to the motor shaft of the second drive motor 321
(5) A third endless belt 325 stretched between the second drive pulley 322 and the second intermediate pulley 323
(6) A fourth endless belt 326 stretched between the second intermediate pulley 323 and the second terminal pulley 324

The upper part of the upper housing 71 is locked to the upper blade unit 251, which constitutes the cutter 25, and fixed to the fourth endless belt 326. Therefore, the position of the cutter 25 on the right side when viewed from the upstream side in the conveyance direction on the rotation shafts 31 and 32 is adjusted by controlling the second drive motor 321.

Among the downstream-side cutters in the conveyance direction, the cutter 24 on the left side when viewed from the upstream side is driven by the drive mechanism C. The drive mechanism C has the following configuration.
(1) A third drive motor 331 provided in an upper portion near the left end of the unit housing 21 when viewed from the upstream side in the longitudinal direction
(2) A third driving pulley 332 fixed to a motor shaft of the third drive motor 331
(3) A third intermediate pulley 333 disposed near the right end when viewed from the downstream side in the longitudinal direction of the unit housing 21, above the upper rotation shaft 33, below the third drive pulley 332, and rotatably disposed around an axis parallel to the motor shaft of the third drive motor 331
(4) A third terminal pulley 334 that is disposed substantially in the center of the unit housing 21 in the longitudinal direction and above the upper rotation shaft 33 and that is disposed rotatably around a shaft parallel to a motor shaft of the third drive motor 331
(5) A fifth endless belt 335 stretched between the third driving pulley 332 and the third intermediate pulley 333
(6) A sixth endless belt 336 stretched between the third intermediate pulley 333 and the third terminal pulley 334

The upper part of the upper housing 71 is locked to the upper blade unit 241, which constitutes the cutter 24 disposed on the downstream side in the conveyance direction and on the left side when viewed from the upstream side, is fixed to the sixth endless belt 336. Therefore, the position of the cutter 24, which is disposed on the downstream side in the conveyance direction and on the right side when viewed from the downstream side, on the rotation shafts 33 and 34 is adjusted by controlling the third drive motor 331.

Among the downstream-side cutters in the conveyance direction, the cutter 26 on the right side when viewed from the upstream side is driven by the drive mechanism D. The drive mechanism D has the following configuration.
(1) A fourth drive motor 341 provided in an upper portion near the left end of the unit housing 21 in the longitudinal direction when viewed from the downstream side
(2) A fourth driving pulley 342 fixed to a motor shaft of the fourth drive motor 341
(3) A fourth intermediate pulley 343 disposed near the left end when viewed from the downstream side in the longitudinal direction of the unit housing 21, above the upper rotation shaft 33, below the fourth drive pulley 342, and rotatably disposed around an axis parallel to the motor shaft of the fourth drive motor 341
(4) A fourth terminal pulley 344 that is disposed substantially in the center of the unit housing 21 in the longitudinal direction and above the upper rotation shaft 33 and that is disposed rotatably around a shaft parallel to a motor shaft of the fourth drive motor 341
(5) A seventh endless belt 345 stretched between the fourth driving pulley 342 and the fourth intermediate pulley 343
(6) An eighth endless belt 346 stretched between the fourth intermediate pulley 343 and the fourth terminal pulley 344

The upper part of the upper housing 71 is locked to the upper blade unit 261, which constitutes the cutter 26 disposed on the downstream side in the conveyance direction and on the right side when viewed from the upstream side, is fixed to the eighth endless belt 346. Therefore, the position of the cutter 26, which is disposed on the downstream side in the conveyance direction and on the left side when viewed from the downstream side, on the rotation shafts 33 and 34 is adjusted by controlling the fourth drive motor 341.

In this example, the first intermediate pulley 313 is a double pulley around which the first endless belt 315 and the second endless belt 316 are wound. The second intermediate pulley 323 is a double pulley around which the third endless belt 325 and the fourth endless belt 326 are wound. The third intermediate pulley 333 is a double pulley around which the fifth endless belt 335 and the sixth endless belt 336 are wound. The fourth intermediate pulley 343 is a double pulley around which the seventh endless belt 345 and the eighth endless belt 346 are wound.

The first terminal pulley 314, the second terminal pulley 324, the third terminal pulley 334, and the fourth terminal pulley 344 are coaxially provided to be independently rotatable.

Therefore, in the blade housing 70 (the upper housing 71 and the lower housing 72) constituting the rotary blade unit X of each cutter, the upper housing 71 is fixed to the endless belt, and the upper housing 71 and the lower housing 72 are connected to each other by the connecting member 73. Therefore, the rotary blade unit X is movable in the axial direction of the rotation shafts while being prevented from rotating around the rotation shafts 31 to 34.

In the above-described configuration example, two pairs of cutters (upstream-side cutters and downstream-side cutters disposed at two different positions in the sheet conveyance direction) are provided in the direction orthogonal to the conveyance direction, and the cutters constituting the pairs are independently movable in the direction orthogonal to the conveyance direction.

Therefore, the bleed width on one side is adjustable by controlling at least one of the first drive motor 311 and the third drive motor 331 and thereby controlling the pair of cutters 23 and 24 on the left side in the conveyance direction (the right side when viewed from the downstream side). Further, the bleed width on the other side is adjustable by controlling at least one of the second drive motor 321 and the fourth drive motor 341 and thereby controlling the pair of cutters 25 and 26 on the right side in the conveyance direction (the left side when viewed from the downstream side). Furthermore, in a case where only the upstream cutters 23 and 25 or the downstream cutters 24 and 26 are used, the sheet can be cut without bleed.

Thus, according to the above configuration, the bleed width can be adjusted, and the sheet can be cut by a single unit (the bleed-width changeable slitter 20). Accordingly, sheets of a single size can be cut into products of various sizes without using multiple units.

### (Fixed Guide Member)

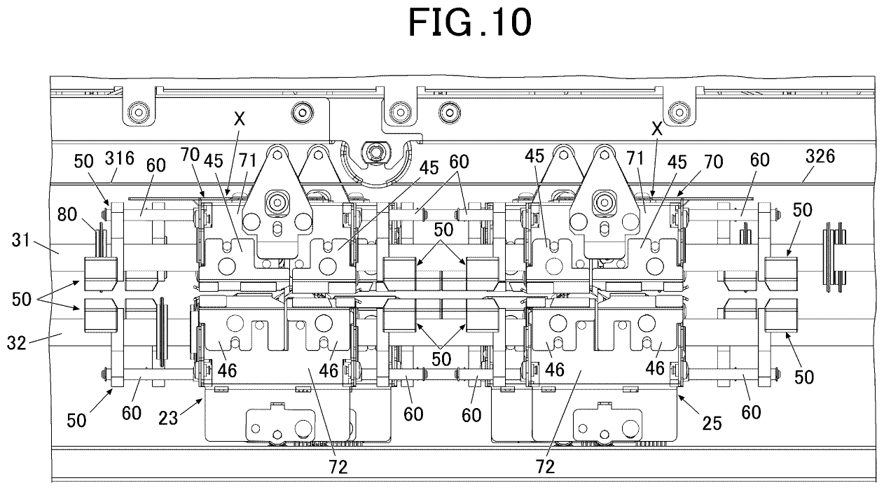

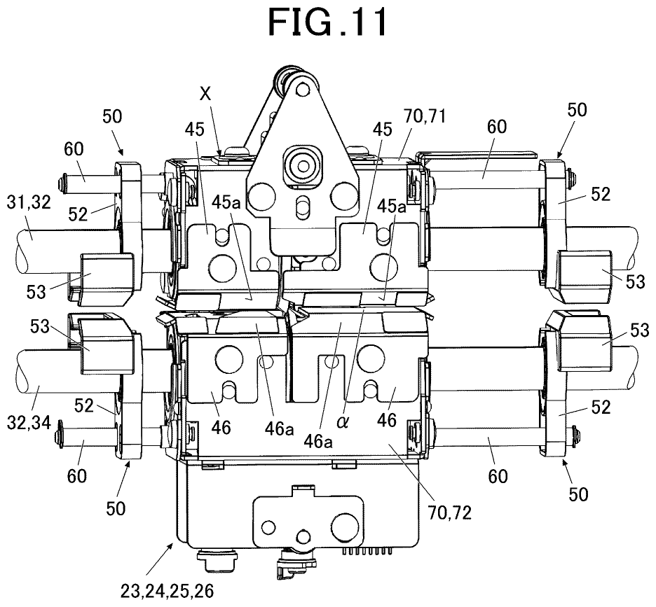

As shown in FIG. 10 and FIG. 11, the cutters 23, 24, 25, and 26 of the bleed-width changeable slitter 20 are provided with fixed guide members 45 and 46 fixed to predetermined positions of the upper housing 71 and the lower housing 72.

The fixed guide members 45 and 46 are attached to the lower part of the upper housing 71 and the upper part of the lower housing 72, respectively, by appropriate fixing means such as screws. The fixed guide members 45 and 46 include tapered parts 45a and 46a at their upstream-side ends. The tapered parts 45a and 46a form a sheet reception port the width of which in the top-bottom direction increases toward the upstream side. The tapered part 45a that inclines upward toward the upstream side is provided at the upstream end of the fixed guide member 45, which is provided to the lower part of the upper housing 71. The tapered part 46a that inclines downward toward the upstream side is provided at the upstream end of the fixed guide member 46, which is provided to the upper part of the upper housing 72.

Each of the fixed guide members 45 and 46 is formed at least from the upstream-end surfaces of the upper housing 71 and the lower housing 72 to a portion facing the conveyance path a (see also FIG. 6) between the upper housing 71 and the lower housing 72. That is, the fixed guide member 45 provided to the upper housing 71 covers at least the lower-end opening of the upper housing 71 from the upstream-side end surface of the upper housing 71 so as not to interfere with the upper cutter blades 231a and 241a. The fixed guide member 46 provided to the lower housing 72 covers the upper-end opening of the lower housing 72 from the upstream-side end surface of the lower housing 72 so as not to interfere with the lower cutter blades 232a and 242a.

The fixed guide members 45 and 46 are appropriately shaped so as not to interference with other members between the blade housing on the upstream side and the blade housing on the downstream side, between the upper housing and the lower housing, and between the right side and the left side in the conveyance direction. It is preferable that multiple fixed guide members 45 and 46 be provided on the lower part of the upper housing 71 and the upper part of the lower housing 72 along the axial direction of the rotation shafts 31, 32, 33, and 34.

With these fixed guide members 45 and 46, the sheet conveyed from the upstream side is certainly guided to the conveyance path a between the upper blade units 231, 241, 251, and 261 (the upper housing 71) and the lower blade units 232, 242, 252, and 262 (the lower housing 72) by the upper and lower tapered parts 45a and 46a. Further, by adjusting the gap between the guide members facing each other in the vertical direction, the sheet can be held when cut by the cutter. Thus, the sheet can be smoothly cut.

### (Movable Guide Member)

The above fixed guide members 45 and 46 are attached to the blade housing 70 and locally guide or support the sheet only at the housing. Therefore, the entire sheet may not be sufficiently guided or supported. Furthermore, in a case where the fixed guide member is provided only at the upstream end of the blade housing 70, the guide member cannot support the sheet after the sheet enters the conveyance path a between the upper housing 71 and the lower housing 72.

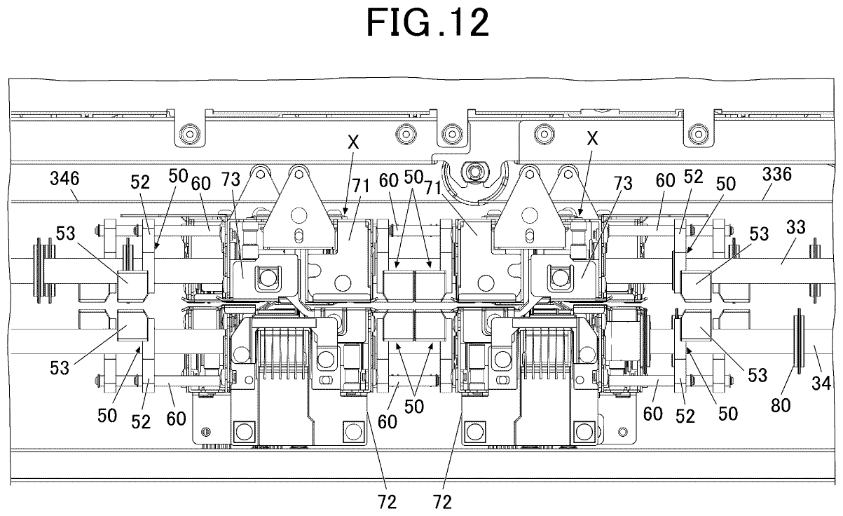

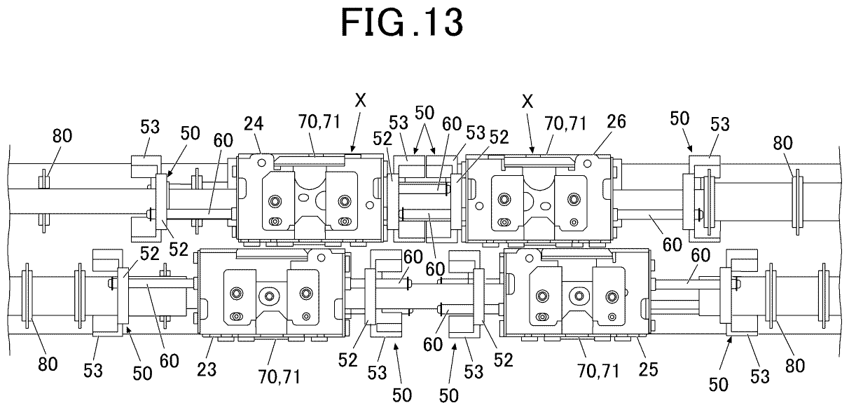

Therefore, as illustrated in FIG. 6 and FIG. 10 to FIG. 13, movable guide members 50 that are movable in the axial direction of the rotation shaft are provided for the respective rotary blade units X (the upper blade unit, the lower blade unit, and the blade housing at both sides of the rotary blade units X on the rotation shaft.

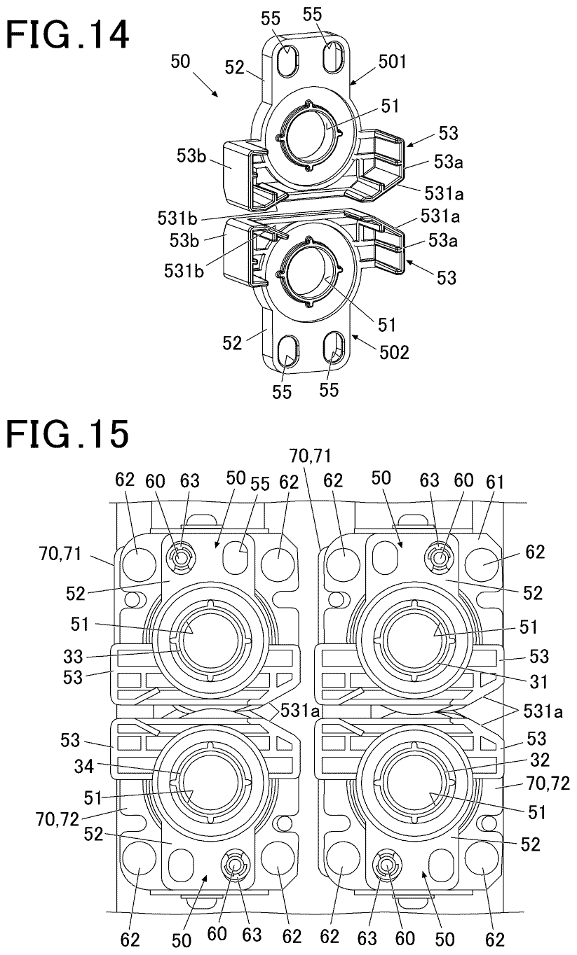

As shown in FIG. 14 and FIG. 15, the movable guide member 50 includes two types of movement guide members 501 and 502 that are mirror symmetrical. One movable guide member (501 or 502) is attached to the upper rotation shaft of the pair of upper and lower rotation shafts (31 and 32, 33 and 34), and the other movement guide member (502 or 501) is attached to the lower rotation shaft. Thus, the movable members 501 and 502 form a pair in the vertical direction.

Each of the movable guide members 50 (501, 502) has an insertion hole 51 through which the rotation shafts 31, 32, 33, and 34 are inserted substantially at the center. The movable guide member 50 includes a plate 52 that has a plate shape and that is substantially perpendicular to the rotation shafts. At one end of the plate 52, a guide piece 53 is provided from the upstream side to the downstream side in the conveyance direction. The guide piece 53 protrudes substantially vertically to the plate 52 and substantially parallel to the rotation shaft by a predetermined width. The width of the guide piece 53 in the conveyance direction is narrow at its central part and is wide at its upstream and downstream ends. The upstream wide part 53a and the downstream wide part 53b have tapered portions 531a and 531b, respectively. The tapered portions 531a and 531b form a sheet reception port the width of which in the up-down direction increases toward the upstream.

The movable guide members 50 are provided on the rotation shafts 31 and 33 of the upper blade unit and the rotation shafts 32 and 34 of the lower blade unit such that the guide pieces 50 face each other with a predetermined space. The pair of upper and lower movable guide members 501 and 502 is disposed such that the tapered portions 531a of their guide pieces 50 face the upstream side and that the portions other than the tapered portions face each other substantially in parallel. Thus, the movable guide members 501 and 502 can continuously support the sheet passing between the pair of movable guide members 501 and 502 from the upstream side to the downstream side of the movable guide members. In this example, the guide piece 53 of the movable guide member 50 protrudes at the side opposite the rotary blade unit X side

The movable guide members 50 can slide on the rotation shafts 31 to 34. On the rotation shafts, multiple ring-shaped rollers 80 are disposed together with the movable guide members 50 (see FIG. 3 and FIG. 8). Springs (not illustrated) are elastically mounted between the rotary blade unit X (the blade housing 70) and the movable guide member 50, between the movable guide member 50 and the roller 80, and between adjacent rollers 80 so as to cover the rotation shaft. The movable guide members 50 are disposed on both sides of the rotary blade unit X (the blade housing 70) on the rotation shaft. The positions of the movable guide members 50 on the rotation shaft are determined by the balance of urging forces of springs disposed at various positions on the rotation shaft. This configuration is described later.

Since the rotation shafts 31, 32, 33, and 34 are rotatable, when the movable guide members 50 are supported only by the rotation shafts 31 to 34, the movable guide members 50 rotate on the rotation shafts 31 to 34. This leads to a failure in the sheet supporting function. Therefore, rotation stoppers 60 that prevent the rotation of the movable guide member 50 are provided. If the rotation stoppers 60 are provided over the entire width of the unit housing 21 in parallel to the rotation shafts as in the known art, the distance between the rotation stoppers 60 and the rotation shafts 31 to 34 are widened to avoid interference with the rotating blades. When a part of the movable guide member 50 near the rotation shaft is urged in the rotation shaft direction by a spring, a large rotation moment acts on the tip end of the movable guide member 50. As a result, torsion between the rotation shaft and the rotation stopper or torsion (rubbing) of the guide member 50 is likely to occur.

To deal with this, the rotation stoppers 60 are provided to the rotary blade unit X. Thus, the rotation stoppers 60 can be provided near the rotation shaft; the torsion between the rotation shaft and the rotation member or the torsion of the movable guide member 50 can be suppressed; and the smooth movement of the guide member 50 can be secured.

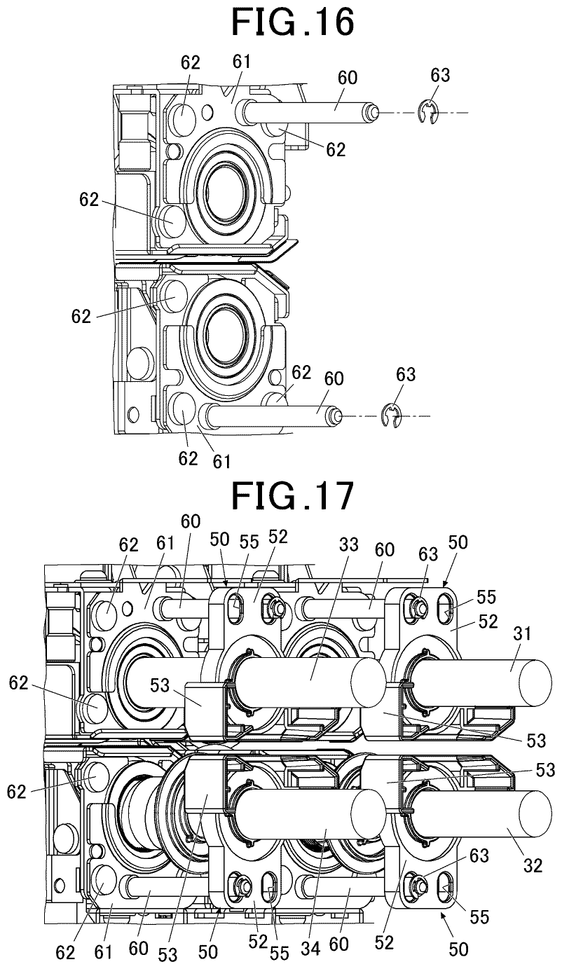

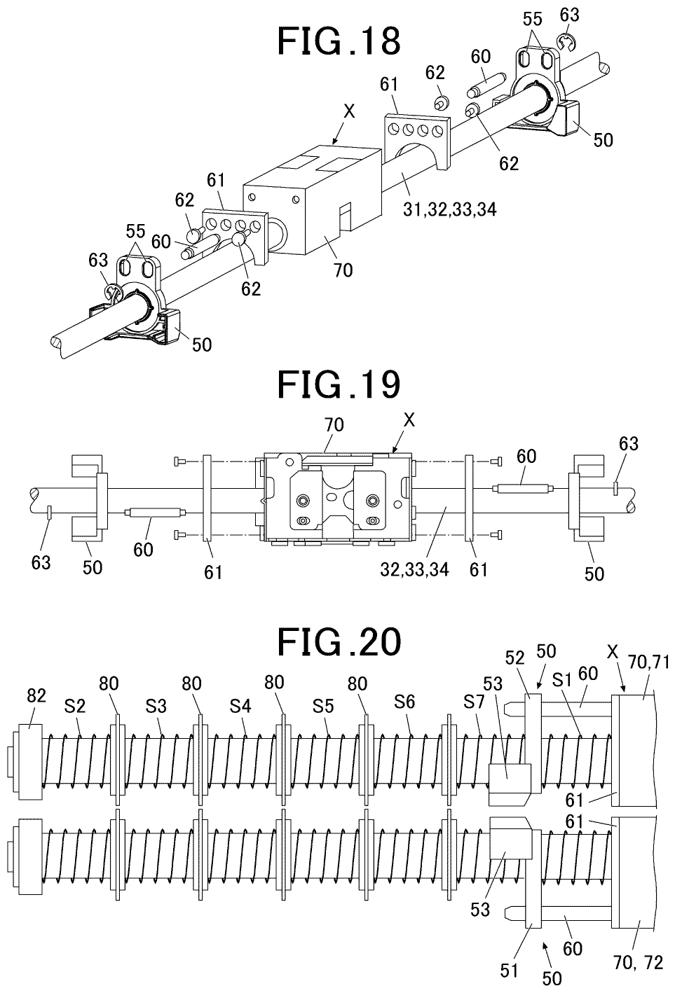

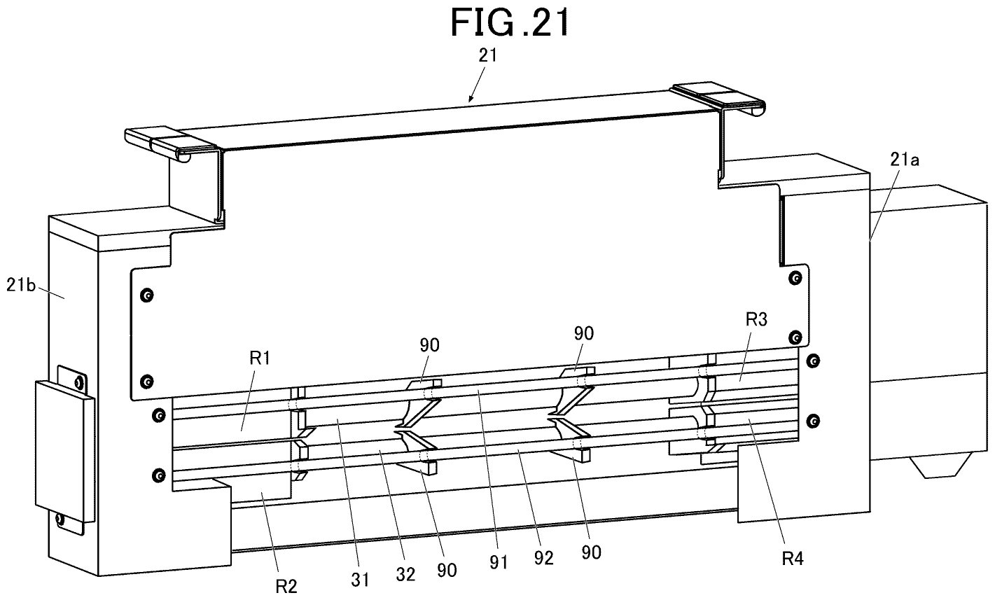

To realize such a configuration, the side plate 61 is fixed to the side surface through which the rotation shaft is inserted of the blade housing 70, which constitutes the rotary blade unit X; the rotation stopper 60 is fixed to the side plate 61; and the rotation stopper 60 is locked to the plate 52 of the movable guide member 50. The rotation stopper 60 is constituted by, for example, a locking pin having a circular cross section, and is attached substantially perpendicularly to the side plate 61 so as to be parallel to the rotation axis. In this example, as illustrated in FIG. 16 to FIG. 19, the side plate 61 is fixed to the side surface of the blade housing 70 through which the rotation shafts 31 to 34 are inserted with screws 62 or the like so as not to interfere with the rotation shafts 31 to 34. One end of the rotation stopper 60 is fixed to the side plate 61 by appropriate means, such as caulking.

When the adjacent rotary blade units X (blade housings 70) come close to each other, the movable guide members 50, which are provided between the adjacent rotary blade units X (blade housings 70) on the rotation shaft, also come close to each other. To avoid interference between the rotation stoppers 60 of the movable guide members 50 close to each other, the rotation stoppers 60 are provided so as to be offset with respect to the vertical plane including the rotation axis.

That is, among the rotation stoppers 60 provided on the side plates 61 of the blade housings 70 adjacent to each other on the rotation axis, the rotation stopper 60 of one housing is provided with a predetermined offset amount toward one of the upstream sides and the downstream side on the vertical plane including the rotation shaft. Further, the rotation stopper 60 of the other housing is provided with a predetermined offset amount toward the other of the upstream side and the downstream side on the vertical plane including the rotation shaft.

Accordingly, the positions where the rotation stoppers 60 of the movable guide members 50 are locked are not necessarily the same. Therefore, on the other end part of the plate 52 of the movable guide member 50, through holes 55 are formed at different positions at the upstream side and the downstream side. The offset amount between the through holes 44 is equal to the offset amount of the rotation stoppers 60 on the vertical plane including the rotation axis. In any of the through holes 55, a positioning member 60 is inserted and locked to the inner peripheral surface of the through hole 55.

According to such a configuration of the movable guide members 50, there is no need to replace the movable guide members 50 no matter whether the rotation stopper 60 is attached to the upstream side or the downstream side on the side plate 52. Thus, only the above two types of movable guide members 50 are needed as common movable guide members.

Further, even if the adjacent movable guide members 50 come close to each other, the rotation stoppers 60 of the movable guide members 50 do not interfere with each other. Therefore, it is possible to secure a wide movable range for each movable guide member 50.

The rotation stopper 60 inserted in the through hole 55 is provided with a stopper ring at its insertion end. The stopper ring prevents the rotation stopper 60 from coming off from the movable guide member 50, supports the movable guide member 50 such that the movable guide member 50 is movable within the range of the axial length of the rotation stopper 60, and maintains the locked state of the movable guide member 50 to the rotation stopper 60.

Further, the movable guide members 50 are disposed on both sides of the rotary blade unit X (the blade housing 70) on the rotation shaft. The positions of the movable guide members 50 on the rotation shaft are determined by the balance of urging forces of springs disposed at various positions on the rotation shaft. FIG. 20 illustrates an example thereof. FIG. 20 illustrates the positioning mechanism for the movable guide members at one position. The same mechanism is applied for the other movable guide members.

Between the blade housing 70 that slides on the rotation shaft and the bearing 82 that supports the rotation shaft, the movable guide member 50 is supported via the rotation stopper 60 while being prevented from rotating. Between the movable guide member 50 and the bearing 82, a plurality of rollers (five rollers in this example) is slidably provided at an equal interval on the rotation shaft.

A spring S1 is disposed around the rotation shaft between the blade housing 70 and the movable guide member 50. Compression springs S2, S3, S4, S5, S6 and S7 are disposed between the bearing 82 and its adjacent roller and between the adjacent rollers.

When the rotary blade unit X moves on the rotation shaft, the rotation stopper 60 fixed via the side plate 61 also moves. At this time, the balance of the spring forces of the spring S1, which is elastically mounted between the blade housing 70 and the movable guide member 50, and the spring members S2 to S5 disposed on the opposite side of the rotary blade unit X (blade housing 70) with the movable guide member 50 in-between changes. Accordingly, the relative position of the movable guide member 50 with respect to the rotation stopper 60 also changes.

Here, unless the spring forces of the spring members S1 to S7 on the rotation shaft are appropriately adjusted, the movable guide member 50 is pressed against the tip part of the rotation stopper 60 and stops along with the movement of the rotary blade unit X (the blade housing 70). Accordingly, the smooth movement of the movable guide member 50 on the rotation shaft may be prevented. To deal with this, the combined spring constant of the plurality of springs S2 to S7 arranged on the side opposite the blade housing 70 with respect to the movable guide member 50 is made greater than the spring constant of the spring S1 arranged between the guide member 50 and the blade housing 70.

By setting the spring constants in this way, it is possible to avoid a state in which the movable guide member 50 stays at the left end of the rotation stopper 60 even when the blade housing 70 moves to the right in the figure. That is, the movable guide member 50 is pressed by the spring members S1 to S7 so as to be held inside the end of the rotation stopper 60. Thus, the smooth movement of the movable guide member 50 on the rotation shaft and on the rotation stopper 60 is not prevented.

As described above, according to the present embodiment, the sheet processing apparatus 200 processes a sheet by rotary blades (the upper cutter blades 231a, 241a, 251a, and 261a and the lower cutter blades 232a, 242a, 252a, and 262a) and includes: the rotary blade unit X that rotatably supports the rotary blades on the rotation shafts 31 to 34; the guide member 50 that is supported by the rotation shaft and that guides a part of the sheet; and the rotation stopper 60 that prevents the guide member 50 from rotating. The rotation stopper 60 is provided to the rotary blade unit X.

Herein, the rotary blades (the upper cutter blades 231a, 241a, 251a, and 261a and the lower cutter blades 232a, 242a, 252a, and 262a) are included in the upper blade units 231, 241, 251, and 261 and the lower blade units 232, 242, 252, and 262.

Furthermore, the rotary blade unit X includes the upper blade units, the lower blade units, and the blade housing 70 (the upper housing 71 and the lower housing 72) that rotatably supports the upper blade unit and the lower blade unit.

According to the above configuration, the distance between the rotation shaft and the rotation stopper is shortened. Therefore, even when a part of the guide member near the rotation shaft is urged and moved, it is possible to avoid torsion between the rotation shaft and the rotation stopper or twisting (rubbing) of the guide member.

Here, the rotation stopper 60 may be provided on the side surface of the housing of the rotary blade unit X (the blade housing 70) in the rotation axis direction. Thus, the distance between the rotation shaft and the rotation stopper can be minimized.

The rotation stopper 60 is preferably provided on the side plate 61 in the rotation axis direction of the housing of the rotary blade unit X (the blade housing 70) such that the rotation stopper 60 is parallel to the rotation axis. By attaching the rotation stopper 60 to the side plate beforehand, the rotation stopper 60 can be easily attached to the housing of the rotary blade unit X.

The rotation stopper 60 can be installed on a separate member provided on the blade housing 70. However, to reduce parts and an assembly error, it is preferable that the rotation stopper 60 is installed on the blade housing of the rotary blade unit X.

The rotation stopper 60 may be provided on the side plate of the rotary blade unit X in the rotation axis direction such that the rotation stopper 60 is parallel to the rotation axis and that the guide member 50 can slide on the rotation stopper 60. When the relative position of the guide member with respect to the rotary blade unit is changed, the guide member is slid on the rotation stopper. Thus, the rotation stopping function of the guide member is maintained.

Further, the guide member may be supported to be movable in the axial direction within the range of the length of the rotation stopper in the axial direction. In such a configuration, the guide member does not come off from the rotation stopper when being moved in the axial direction. Therefore, the guide member can be kept from rotating and does not affect sheet cutting.

Here, the guide member may be supported by springs disposed on the rotation shaft so as to be movable in the axial direction of the rotation shaft. In such a configuration, the position of the guide member is determined by the urging force of the springs. Therefore, the position of the guide member is stabilized.

Further, the guide members and a plurality of rollers may be provided on both sides of the rotary blade unit X in the rotation shaft direction so as to be slidable on the rotation shaft. When the guide member is provided only on one side of the rotary blade unit in the rotation axis direction, the sheet may not be appropriately guided on the side where the guide member is not provided. When the guide members are provided on both sides of the rotary blade unit in the rotation axis direction, it is possible to reliably guide (support) the end parts of the sheet, and smooth conveyance and cutting of the sheet are secured.

Herein, the guide member may be provided adjacent to the rotary blade unit X, and the plurality of rollers may be provided on a side opposite the rotary blade unit X with respect to the guide member.

The springs may be disposed between the rotary blade unit X and the guide member, and between members on the opposite side of the rotary blade unit X with respect to the guide member.

According to such a configuration, the guide member can be held at a predetermined position with respect to the rollers and the rotary blade unit via the springs by adjusting the spring at the rotary blade unit side of the guide member and the springs at the roller side of the guide member.

Herein, it is preferable that the combined spring constant of the springs disposed on the side opposite the rotary blade unit X with respect to the guide member is greater than the spring constant of the spring disposed between the guide member and the rotary blade unit X.

Thus, the guide member is prevented from staying at the end of the rotation stopper.

Further, the sheet processing apparatus 200 includes the unit housing 21 that supports the rotation shaft. The rotation stopper 60 is provided at part of the rotation shaft supported by the unit housing 21.

That is, the rotation stopper 60 is not provided over the entire width of the unit housing 21 in the rotation axis direction. Therefore, it is possible to avoid an increase in the size of the module for providing the rotation stopper 60.

There may be multiple rotary blade units X (the upper blade units 231, 241, 251, and 261, the lower blade units 232, 242, 252, and 262, and the housing 70) may be arranged on the rotation shafts. The adjacent rotary blade units X on the rotation shaft each have the rotation stoppers on their side surfaces facing each other. The rotation stoppers, which are provided on the side surfaces facing each other, may be arranged to be shifted in directions orthogonal to the rotation shaft (i.e., may be arranged at different positions on a plane orthogonal to the rotation shaft) so that the rotation stoppers do not collide with each other.

Furthermore, the multiple rotary blade units X may be arranged in the sheet conveyance direction. With the rotary blade units arranged in the conveyance direction, the trim width can be changed.

The image forming system according to the above embodiment includes an image forming apparatus that forms an image on a sheet and the above-described sheet processing apparatus that performs sheet processing on the sheet on which the image has been formed by the image forming apparatus. When the above-described sheet processing apparatus is adopted, it is possible to form an inline type image forming system that includes a slitter capable of changing the trim width as one functional unit.

### <Others>

Although the embodiment and modification examples of the sheet processing apparatus and the image forming system including thereof according to the present invention have been described, the present invention is not limited to the above-described embodiment and modification examples. The present invention also includes embodiments obtained by applying various modification examples conceived by those skilled in the art to the above-described embodiments and modification examples, and embodiments realized by suitably combining the constituent elements and functions in the embodiments and modifications without departing from the spirit of the present invention. The scope of the present invention is to be interpreted by the appended claims.

The present invention is useful as a technique for preventing rotation of a movable guide member that supports a sheet.

1. A sheet processing apparatus that processes a sheet using a rotary blade, the sheet processing apparatus comprising:
a rotary blade unit that supports the rotary blade such that the rotary blade is rotatable on a rotation shaft and movable in an axial direction of the rotation shaft;
a guide member that is supported by the rotation shaft and that guides part of the sheet; and
a rotation stopper that prevents rotation of the guide member,
wherein the rotation stopper is provided to the rotary blade unit.

2. The sheet processing apparatus according to claim 1, wherein the rotation stopper is provided on a side surface of the rotary blade unit, the side surface being at an end in the axial direction.

3. The sheet processing apparatus according to claim 1, wherein the rotation stopper is provided on a side plate provided at an end of the rotary blade unit in the axial direction such that the rotation stopper is parallel to the rotation shaft.

4. The sheet processing apparatus according to claim 1, wherein the rotary blade unit includes a housing that houses the rotary blade.

5. The sheet processing apparatus according to claim 1, wherein:
the rotation stopper is provided on a side plate of the rotary blade unit in the axial direction such that the rotation stopper is parallel to the rotation shaft, and
the guide member is configured to slide on the rotation stopper.

6. The sheet processing apparatus according to claim 5, wherein the guide member is supported to be movable in the axial direction within a range of a length of the rotation stopper in the axial direction.

7. The sheet processing apparatus according to claim 1, wherein the guide member is movable in the axial direction by springs disposed on the rotation shaft.

8. The sheet processing apparatus according to claim 1, further comprising rollers, wherein the guide member and the rollers are provided on both sides of the rotary blade unit in the axial direction such that the guide member and the rollers can slide on the rotation shaft.

9. The sheet processing apparatus according to claim 8, wherein:
the guide member is adjacent to the rotary blade unit, and
the rollers are provided on a side of the guide member opposite the rotary blade unit.

10. The sheet processing apparatus according to claim 9, wherein:
the guide member is movable in the axial direction by springs disposed on the rotation shaft, and
among the springs, a first spring is disposed between the rotary blade unit and the guide member, and a second spring is disposed between members provided on the side of the guide member opposite the rotary blade unit.

11. The sheet processing apparatus according to claim 10, wherein a combined spring constant of the second spring disposed on the side of the guide member opposite the rotary blade unit is greater than a spring constant of the first spring disposed between the rotary blade unit and the guide member.

12. The sheet processing apparatus according to claim 1, further comprising a unit housing that supports the rotation shaft,
wherein the rotation stopper is provided on part of the rotation shaft supported by the unit housing.

13. The sheet processing apparatus according to claim 1, wherein multiple rotary blade units each of which is the rotary blade unit are arranged on the rotation shaft.

14. The sheet processing apparatus according to claim 13, wherein:
rotation stoppers each of which is the rotation stopper are provided on side surfaces of the rotary blade units adjacent to each other on the rotation shaft, the side surfaces facing each other, and
the rotation stoppers are disposed at different positions on a plane orthogonal to the rotation shaft such that the rotation stoppers do not interfere with each other.

15. The sheet processing apparatus according to claim 1, wherein multiple rotary blade units each of which is the rotary blade unit are arranged in a sheet conveyance direction.

16. The sheet processing apparatus according to claim 15, wherein the sheet processing apparatus is configured to change a trim width of the sheet by using the rotary blade units arranged in the sheet conveyance direction.

17. An image forming system comprising:
an image forming apparatus that forms an image on a sheet; and
the sheet processing apparatus according to claim 1 that performs sheet processing on the sheet on which the image has been formed by the image forming apparatus.
